(19) United States
(12) Patent Application Publication
(10) Pub. No.: US 2024/0074569 A1
(43) Pub. Date: Mar. 7, 2024

(54) GRILL CLEANING TOOL HAVING A SCRAPER AND A SELECTIVLEY REMOVABLE BRUSH

(71) Applicant: Mario E. Magnani, Springfield, MA (US)

(72) Inventor: Mario E. Magnani, Springfield, MA (US)

(21) Appl. No.: 18/220,575

(22) Filed: Jul. 11, 2023

Related U.S. Application Data
(60) Provisional application No. 63/388,118, filed on Jul. 11, 2022.

(51) Int. Cl. A46B 5/00; A47J 37/07

(52) U.S. Cl. CPC A46B 5/0095; A47J 37/0786

(57) ABSTRACT

A grill cleaning tool includes a tool handle extending between handle rear and forward ends. A forwardly-extending rigid plate depends from the tool handle to a distal scraping edge disposed forwardly of the handle forward end and configured for scraping surfaces to be cleaned. The tool further includes a readily removable brush element having a brush head defined by a plurality of bristles. The brush element and rigid plate are dimensioned and configured relative to one another such that, when the brush element is attached to the tool handle with the rigid plate, at least some of the bristles of the brush head extend longitudinally forward of the distal scraping edge. Adherence to these dimensional parameters facilitates use of the scraping edge without interference from the brush head and, conversely, use of the brush head without interference from the scraping edge with the brush element, respectively, removed and attached.

### PROVISIONAL PRIORITY CLAIM

Priority based on Provisional Application Ser. No. 63/388,118 filed Jul. 11, 2022 under the title “GRILL CLEANING TOOL HAVING A SCRAPER AND A SELECTIVELY REMOVABLE BRUSH” is claimed. Moreover, the entirety of the previous provisional application, including the drawings, is incorporated herein by reference as if set forth fully in the present application.

### BACKGROUND

Numerous, variously-configured implements for cleaning cooking grills exist. These implements typically take the form of brushes, scrapers, or some combination of a brush and scraper. A basically-configured combination of a brush and scraper includes a handle with a distal end having a lower side from which protrude a plurality of bristles defining a brush and an upper side to which there is affixed a scraper blade. One issue with this familiar configuration is that the bristles wear out long before the handle or scraper blade does. Moreover, it is usually the forwardmost bristles that wear first, while more rearward bristles remain perfectly serviceable. As a result, brushes are frequently discarded—handle and all—after the forwardmost bristles are worn, but with the bristles located nearest the handle, as well as the scraper, still in near-new condition.

Additionally, grill brushes conforming to the basic configuration described above do not permit the bristles to reach the full lengths of the grill-grate bars, for example, before the scraping edge of the scraping blade contacts the side of the firebox, thereby preventing further translation across the surface to be cleaned. Conversely, in some designs, full access to surfaces by the scraper is impeded by the bristles of the brush portion contacting surfaces of the cooking grill.

Accordingly, a need exists for a grill cleaning tool including both a brush and a scraper that, in at least one aspect, facilitates (i) replacement of a brush element including bristles with a new brush element when the bristles are worn and, in another aspect, (ii) selective detachment and reattachment of the same brush element relative to the scraper in order to facilitate access to various grill surfaces by the brush and scraper.

### SUMMARY

In a first embodiment generally illustrative of the invention, a grill cleaning tool includes an elongated tool handle with a grip portion configured for grasping by a human hand. The tool handle has a lengthwise extent disposed generally along a longitudinal handle axis between handle rear and forward ends.

Integrally formed with, attached to, or otherwise depending from the tool handle is a rigid plate. Illustratively configured, the rigid plate extends forwardly of the handle forward end and has a distal edge. For purposes of consistent spatial and directional orientation, unless otherwise noted, relative terms such as “rearward of” and “forward of” are defined with respect to a user of the grill cleaning tool but also, in more “self-contained” and universally applicable terms, with reference to the handle rear end, which is always regarded as rearward of the handle forward end, irrespective of how a user grasps the grill cleaning tool at any given time, or if anyone is holding it at all.

In various configurations, the rigid plate is configured as a scraping blade, the distal edge of which defines a scraping edge configured for engaging and scraping surfaces to be cleaned. At least when the rigid plate is configured as a scraping blade, it is preferable that at least the scraping edge thereof be fabricated from a metal, such as steel. However, whether or not the rigid plate is configured as a scraping blade, and the distal thereof defines a scraping edge, the rigid plate may be variously configured such that the distal edge extends laterally along an edge axis orthogonal to the longitudinal handle axis. Moreover, the rigid plate may be directly attached to the tool handle or attached through an intermediate plate mount. Additionally, in each of various embodiments, the rigid plate alternatively or additionally serves to structurally retain and support at least one grill-grate cleaning implement for removing debris from the side and bottom surfaces of grill-grate bars. Such an implement may be configured as a grill-grate-abrading tine, which may alternatively be referred to or embodiment as a “bore” or “pick.” The at least one grill-grate-abrading tine most preferably depends from the rigid plate in a location forward of the handle forward end.

The grill cleaning tool further includes a brush element. Variously configured, the brush element includes a brush-element base to which is mounted, or from which otherwise depends, a brush head defined by a plurality of bristles. The brush-element base is selectively securable to a brush-element mount defined on the handle and situated more proximate to the handle forward end than to the handle rear end. In each of various configurations, the selective securement of the brush element to the handle is accomplished through fastener mechanism including a quick-release lever and lug arrangement held captive within the handle forward end and the brush-element mount. Alternatively, but non-limitingly, the brush element is securable to the brush-element mount with a simpler-to-manufacture fastener mechanism including a threaded shaft and an enlarged knob from which the threaded shaft extends. Regardless of the particular configuration of the fastener mechanism, it is preferred that it facilitate toolless removal and securement of the brush element to the tool handle. The brush element and rigid plate are dimensioned and configured in accordance with parameters important to the functionality of the grill cleaning tool when the brush element is alternatively attached to and detached from the tool handle. Most specifically, in order to facilitate a key objective of various alternative embodiments, the brush element and rigid plate are dimensioned such that, when the brush element is attached to the tool handle, at least some of the bristles of the brush head extend longitudinally forward of the distal edge of the rigid plate and, where applicable, the tine(s). Observation of this parameter facilitates use of the brush head to engage, with the bristles, surfaces to be cleaned without interference or impedance from the distal edge and/or tine(s).

Although the tool depicted and disclosed is described primarily as a grill cleaning tool, this is merely because that is the context that inspired the invention. A tool of the general configuration disclosed could have additional or alternative applications. For instance, in stripping furniture for refinishing, both scrapers and wire brushes are used, frequently in combination with chemical solvents. A single tool comprising the elements generally disclosed herein could just as readily find application in surface preparation, such as stripping old finishes from furniture.

In addition to other variations applicable to objects and surfaces other than a grill, alternative versions are envisioned in which the element so far identified as a brush element includes surface-abrading sub-elements other than bristles. For example, instead of bristles, the “brush element” might be a surface-engaging element comprising a pad, mesh, screen, or other surface-engaging structure fabricated from at least one of (i) of polymeric material, (ii) silicon, (iii) fibers, (iv) rubber, (v) foam, and (vi) fabric, depending on the intended application. In such an embodiment, the same basic parameters important to the functionality of the grill cleaning tool when the brush element is alternatively attached to and detached from the tool handle would apply, most specifically, the surface-engaging element and rigid plate would be dimensioned and configured such that, when the surface-engaging element is attached to the tool handle with the rigid plate, at least some portion of the surface-abrading sub-element(s) extend forwardly of the distal edge of the rigid plate.

Representative embodiments are more completely described and depicted in the following detailed description and the accompanying drawings.

### BRIEF DESCRIPTION OF THE DRAWINGS

FIG. 1 is a top perspective view of a grill cleaning tool including, in accordance with a first embodiment, an elongated tool handle, a brush element, and a rigid plate configured as a scraping blade having a distal scraping edge that is disposed forwardly of the tool handle forward end and extends laterally to the lengthwise extent of the tool handle, and wherein the brush element is selectively removable from the tool handle;

FIG. 1A is a top perspective of a grill cleaning tool including, in accordance with a second embodiment, an elongated tool handle, a brush element, and a rigid plate having a distal edge that, while not configured as a scraping edge, is also disposed forwardly of the tool handle forward end, and wherein the brush element is selectively removable from the tool handle;

FIG. 2 is an isolated perspective view of the brush element of the grill cleaning tool shown in FIGS. 1 and 1A;

FIG. 3 is an exploded perspective view of the tool handle, brush element, and the two alternative rigid plates of the grill cleaning tool shown in FIGS. 1 and 1A;

FIG. 4 is a bottom perspective view of a grill cleaning tool as embodied in FIG. 1 with the selectively removable brush element separated from the tool handle;

FIG. 4A is an isolated view of a fastener in the form of a brush-mounting key by which the brush element is removably mounted to the tool handle in the illustrative embodiment of FIGS. 1-4;

FIG. 5A depicts the grill cleaning tool in accordance with the second embodiment of FIGS. 1 and 4 with the brush element removed so that the scraping edge defined by the distal edge of the rigid plate can engage the top surfaces of grill-grate bars to remove debris therefrom;

FIG. 5B depicts how tines carried by the rigid plate of the second embodiment engage the side surfaces of grill-grate bars to remove debris therefrom;

FIG. 5C shows the illustrative first embodiment with the brush element attached to the handle and with bristles thereof engaging the top surfaces of grill-grate bars to remove debris therefrom;

FIG. 6 is a top perspective view of a grill cleaning tool including, in accordance with a second embodiment, an elongated tool handle, a brush element, and a rigid plate configured as a scraping blade having a distal scraping edge that is disposed forwardly of the tool handle forward end and extends laterally to the lengthwise extent of the tool handle, and wherein the brush element is separated from the tool handle;

FIG. 7 is a bottom perspective view of a grill cleaning tool including, in accordance with a third embodiment, an elongated tool handle, a brush element, and a rigid plate configured as a scraping blade having a distal scraping edge that is disposed forwardly of the tool handle forward end and extends laterally to the lengthwise extent of the tool handle, and wherein the brush element is separated from the tool handle; and

FIG. 8 is a detailed side view of a specially configured grill-grate-abrading tine suitable for effective cleaning of at least two general types of grill-grate bars.

### DETAILED DESCRIPTION

The following description of a variously configured grill cleaning tool having a scraper and a selectively removable brush is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims.

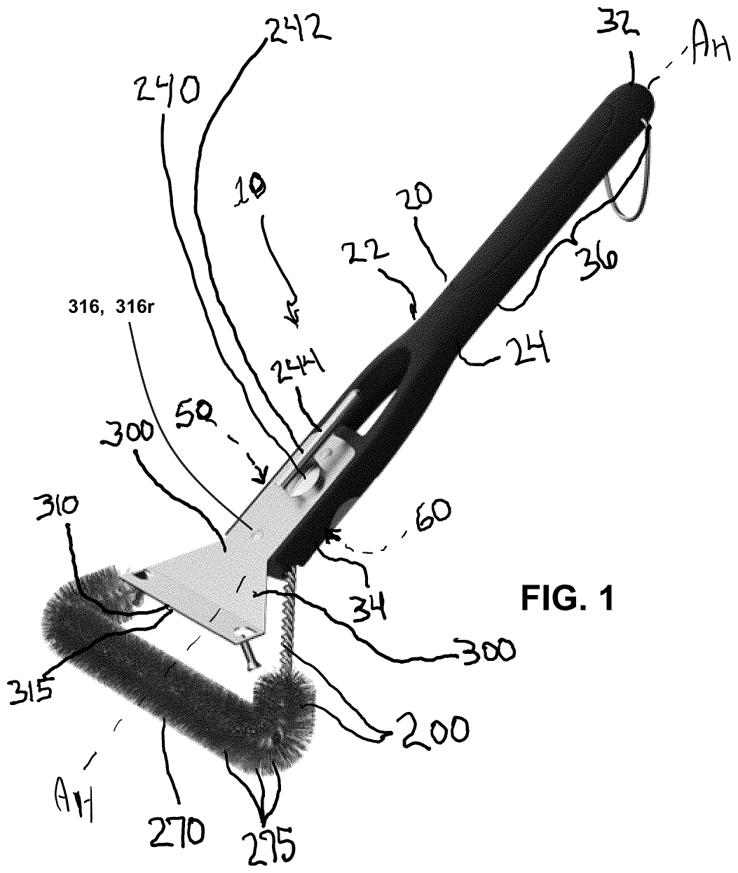

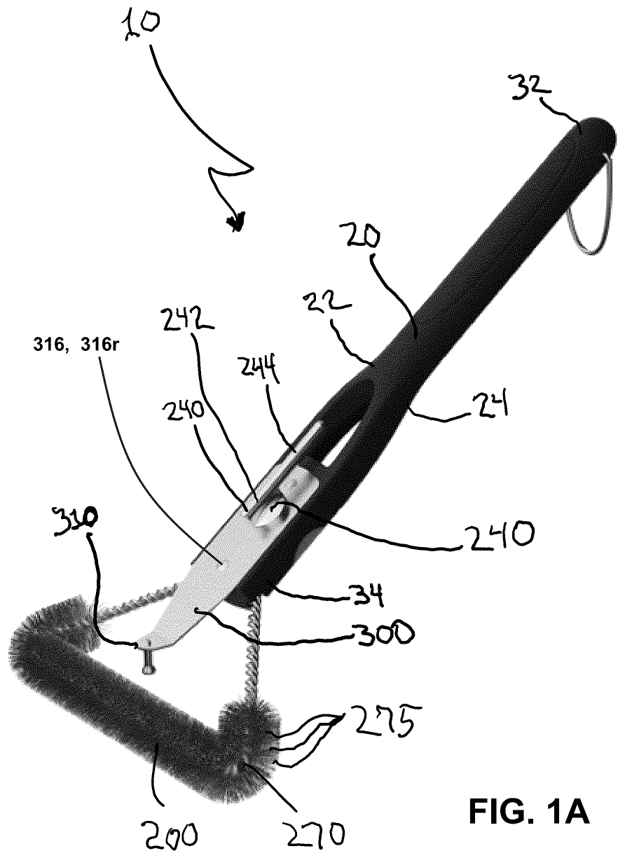

Shown in the included drawings are various views and illustrative versions of a grill cleaning tool generally referenced by the reference number 10. A basic, first embodiment is described initially with general reference to FIGS. 1-4A. Moreover, for the sake of efficiency and descriptive clarity, illustrative, non-limiting additions, optional features, and alternative configurations of various elements are described with conjunctive reference to the basic illustrative configuration of the embodiments of FIGS. 1-4A. Additionally, throughout the specification and drawings, like elements across alternative embodiments, or various views of the same embodiment, are referenced by similar or identical numeric and/or alphanumeric reference characters. Moreover, for purposes of clarity, when versions alternative to a version previously discussed share most of the same major elements, major elements in the later, alternative version might not be labeled with reference numbers if the identification of those components can be clearly inferred by virtue of examination of another version in which those same or corresponding components are labelled with reference numbers. Alternative versions are discussed primarily with reference to how they differ from another version already described in detail; use of reference numbers is correspondingly judicious.

Referring initially to FIG. 1, an illustrative first embodiment of a grill cleaning tool 10 includes a tool handle 20 having tool-handle top and bottom surfaces 22 and 24. Although contoured, the tool-handle top and bottom surfaces 22 and 24 extend lengthwise generally along a handle axis A_{H} between handle rear and forward ends 32 and 34. Because the grill cleaning tool 10 is configured for use in alternative orientations, the initial designation of handle top and bottom surfaces 22 and 24 is, in fact, arbitrary. The tool handle 20 further includes a grip portion 36 configured for grasping by a human hand and extending from the handle rear end 32 toward the handle forward end 34.

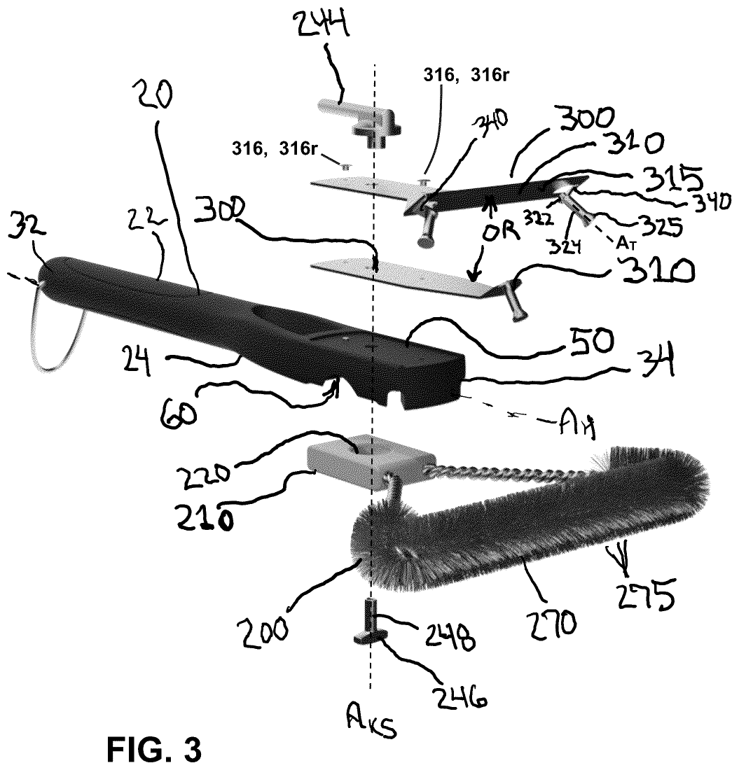

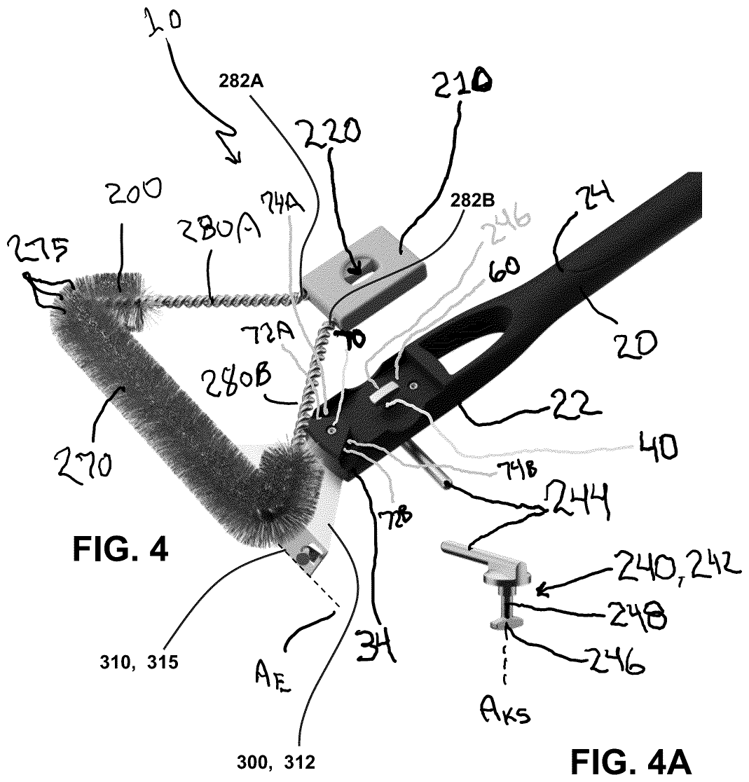

Referring to the assembled and exploded views of, respectively, FIGS. 1 and 3, the handle forward end 34 includes along the handle top surface 22 a plate mount 50 configured for mounting thereon a rigid plate 300 for purposes to be described later in the present description. Also explained later in this description, with conjunctive reference to FIGS. 3 and 4, are the purpose and functionality of a brush-element mount 60 defined within and along the handle bottom surface 24 at the handle forward end 24.

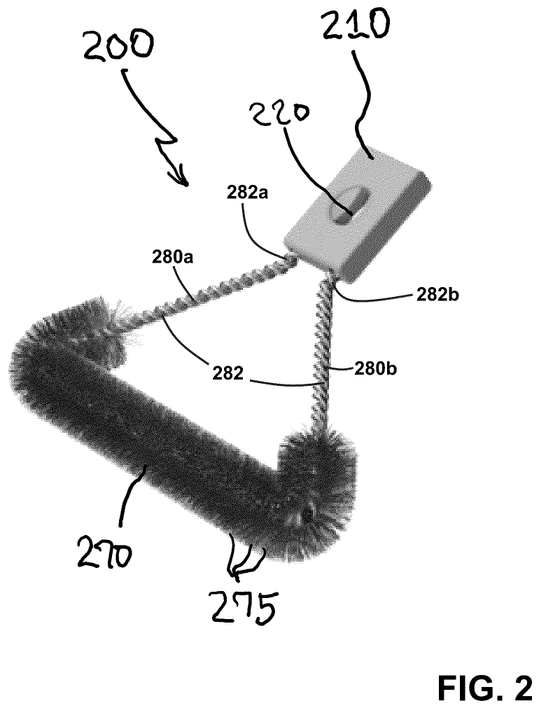

The grill cleaning tool 10 further includes a selectively removable brush element 200, which, while depicted in all figures, is described initially with principal reference to FIGS. 2, 3, and 4. The brush element 200 includes a brush-element base 210 that carries a brush head 270 defined by a plurality of bristles 275. The brush-element base 210 may be configured as a plate or block fabricated of metal or plastic, for example. However, regardless of the particular configuration of the brush-element base 210, or the material from which it is fabricated, the brush-element base 210 and the brush-element mount 60 illustratively depicted most clearly in FIGS. 3 and 4 are complementarily configured such that, when the brush element 200 and the tool handle 20 are operatively assembled, the brush-element base 210 is captured by and “nests” within or upon the brush-element mount 60. In each of various embodiments, the brush element 200 is removably retained by the tool handle 20 by means of at least one fastener 240 that selectively engages the handle forward end 34 and the brush-element base 210.

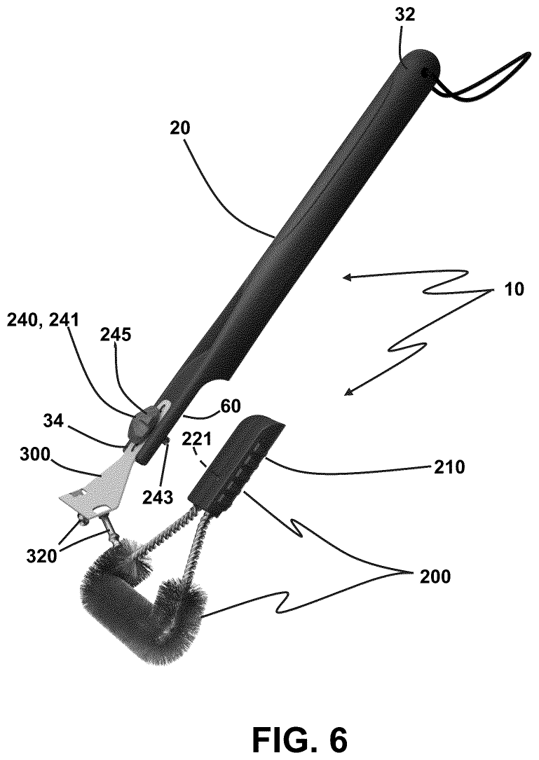

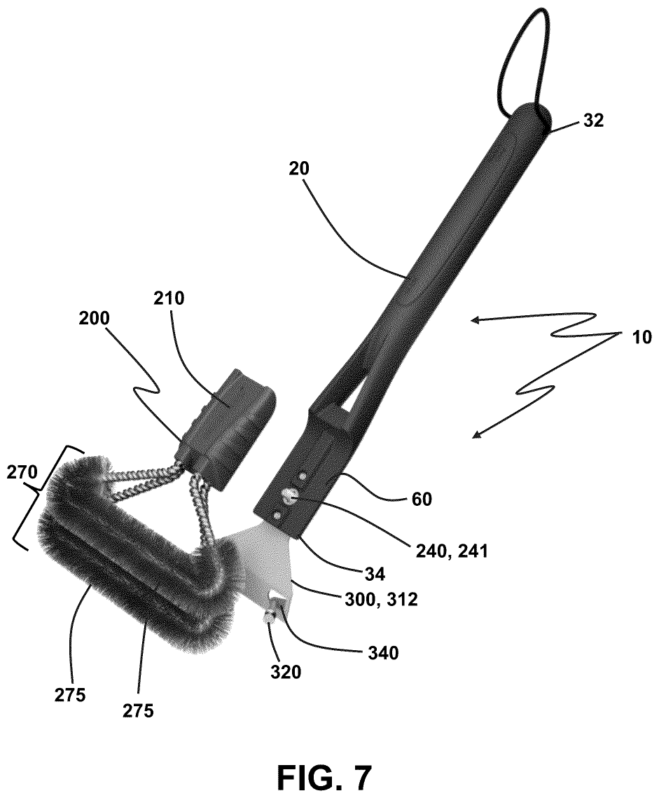

In each of various versions, the at least one fastener 240 by which the brush element 200 is removably mounted to the tool handle 20 may be, or include, a threaded fastener such as a screw or bolt. Moreover, that fastener may be a “captive fastener” irremovably retained by either the brush-element base 210 or the handle forward end 34. Whereas versions in which the fastener 240 is a threaded fastener are considered later with conjunctive reference to FIGS. 6 and 7, in the non-limitingly illustrative version depicted in FIGS. 1-5C, with the exception of FIG. 2, the fastener 240 is configured as a brush-mounting key 242. As seen most clearly in the bottom-side view of FIG. 4, the brush-mounting key 242 is shown captured within the handle forward end 34. With continued referenced to FIG. 4, as well as the associated view of FIG. 4A in which a brush-mounting key 242 is shown in isolation, the brush-mounting key 242 includes a key lever 244, a keyed (e.g., non-circular) lug 246, and a key shaft 248 connecting the key lever 244 to the keyed lug 246.

As seen in FIG. 4, when the brush-mounting key 242 is installed within the forward handle end 34, the key lever 244 is situated along and disposed above the handle top surface 22, the keyed lug 246 is disposed within the brush-element mount 60 along and below the handle bottom surface 24, and the key shaft 248 extends through a key-shaft aperture 40 defined through the material from which the handle forward end 34 is fabricated. While the key shaft 248 is retained for rotation within the key-shaft aperture for rotation about a key-shaft axis A_{KS}, the key lever 244 and keyed lug 246 are enlarged relative to the key shaft 248 such that neither can pass through the key-shaft aperture 40, thereby retaining the brush-mounting key 242 captive by the handle forward end 34.

By means of the key lever 244, the brush-mounting key 242 is rotatable between locked and unlocked positions shown in, respectively, the top perspective view of FIG. 1 and the bottom perspective view of FIG. 4. With reference to FIG. 4, it can be seen that the brush-element base 210 has defined therein—all the way through in this case—a keyed lug aperture 220 configured for selectively receiving therein and therethrough the keyed-lug 246 of the brush-mounting key 242. An “unlocked” angular orientation of the brush-mounting key 242 is one in which the “complementarily keyed” lug aperture 220 and keyed lug 246 are angularly aligned in a way that permits the brush-element base 210 to mountably engage with, or be removed from, the brush-element mount 60. With the brush-element base 210 nested with the brush-element mount 60, and the keyed lug 246 protruding through the lug aperture 220, the brush-mounting key 242 can be rotated to a “locked” angular orientation in which the keyed lug 246 and lug aperture 220 are misaligned such that the keyed lug 246 cannot pass through the lug aperture 220 and, thereby, the brush-element base 210 cannot be removed from the brush-element mount 60. That is, misalignment of the keyed lug 246 and lug aperture 220 results in selective mechanical interference (locking interference) that retains the brush element 200 on the tool handle 20. Although no bottom view of the brush-element base 210 locked within the brush-element mount 60 is shown, the appearance of same can be readily envisioned by one possessing the requisite “ordinary skill” who views FIGS. 1 and 4 in conjunction with the present description and, therefore, this functional aspect is adequately disclosed and enabled.

Shown in the top-left side and bottom-right side disassembled views of, respectively, FIGS. 6 and 7 are alternative versions in which, among other differences from the embodiments of FIGS. 1-5C, the fastener 240 by which the brush element 200 is attached to the tool handle 20 is a threaded fastener 241 including an externally-threaded shaft 243 and an enlarged knob 245 by which a user can apply torque to tighten and loosen the threaded fastener 241. In this illustrative version, the knob 245 is disposed along the tool-handle top surface 22, while the threaded shaft 243 depending therefrom extends through the handle forward end 34 from where it protrudes downwardly from the brush-element mount 60. Defined within the brush-element base 210 is an internally-threaded bore 221 configured for threadably receiving and retaining the threaded shaft 243 in order to secure the brush element 200 to the tool handle 20.

In other way in which the versions of FIGS. 6 and 7 differ from the versions of FIGS. 1-5C is in the configurations (i.e., shapes) of the brush-element mount 60 and the brush-element base 210. Whereas in the first version considered, the brush-element base 210 nests within a relatively recessed brush-element mount 60 defined at the handle forward end 34, in the version presently under consideration deviates from that design, although, importantly, the mutually-contacting surfaces of the brush-element mount 60 and brush-element base 210 are still complimentarily keyed so that they “nest” in order to prevent undesired relative rotation between them when the brush element 200 is secured to the handle 20.

In the various embodiments illustratively depicted in the accompanying drawings, each brush head 270 is joined to the brush-element base 210 by first and second brush-head support arms 280a and 280b. The support arms 280a and 280b mutually diverge away from the brush-element support base 210 toward the brush head 270. In all of the particular versions shown, the support arms 280a and 280b are defined by the same run of twisted wire 282 that starts at a twisted-wire first end 282a at the brush-element base 210, extends out to the brush head 270, bends through and forms part of the brush head 270, and then bends back toward and extends to a second twisted-wire end 282b at the brush-element base 210. The use of mutually parallel runs of wire twisted to form a helix that holds finer wire strands (bristles) is known in the art, and included on existing brushes. However, as explained with reference to FIG. 4, a feature of the embodiments of FIGS. 1-5C is the inclusion at the handle forward end 34 of bulkhead 70 situated at, and protruding downwardly from, the brush-element mount 60.

The bulkhead 70 includes first and second bulkhead walls 72A and 72B that mutually diverge at an angle corresponding to the angle at which the brush-head support arms 280a and 280b mutually diverge. Moreover, the first and second bulkhead walls 72A and 72B include, respectively, first and second concave arcuate support channels 74A and 74B. As the brush-element base 210 is nested within the brush-element mount 60, the first and second brush-head support arms 280a and 280b are received within, and cradle by, respectively, the first and second concave arcuate support channels 74A and 74B, thereby stabilizing and rendering more secure against undesired movement the brush element 200 relative to the tool handle 20.

Among additional differences between the versions of FIGS. 1-5C and those of FIGS. 6 and 7 is that each of the versions of FIGS. 6 and 7 lacks a bulkhead 70 such as that described relative to the version of FIGS. 1-5C. Moreover, in the version of FIG. 7, the brush element 200 illustratively includes two brush heads 270 depending from the brush-element base 210. From this later example, it is to be understood that, in any particular design variation, a brush element 200 may generally include a single brush-element base 210 from which depends on or more brush heads 270.

As introduced in the summary, and previously stated in the detailed description, the grill cleaning tool 10 further includes a rigid plate 300. As shown in the various drawings, while the configurations of rigid plates 300 may vary, each rigid plate 300 general includes a distal edge 310 and is mounted to the tool handle 20 such that the rigid plate 300 extends forwardly of the handle forward end 34. More specifically, the distal edge 310 is disposed forwardly of the handle forward end 34. FIGS. 1 and 4-7 depict rigid plates 300 having a configuration different from the illustrative configuration of the rigid plate 300 shown in FIG. 1A. Nevertheless, these disparately configured rigid plates 300 have some features and functionality in common. The exploded view of FIG. 3 shows both types of rigid plate 300, indicating that any particular embodiment of the grill cleaning tool 10 can include alternative types of rigid plate 300.

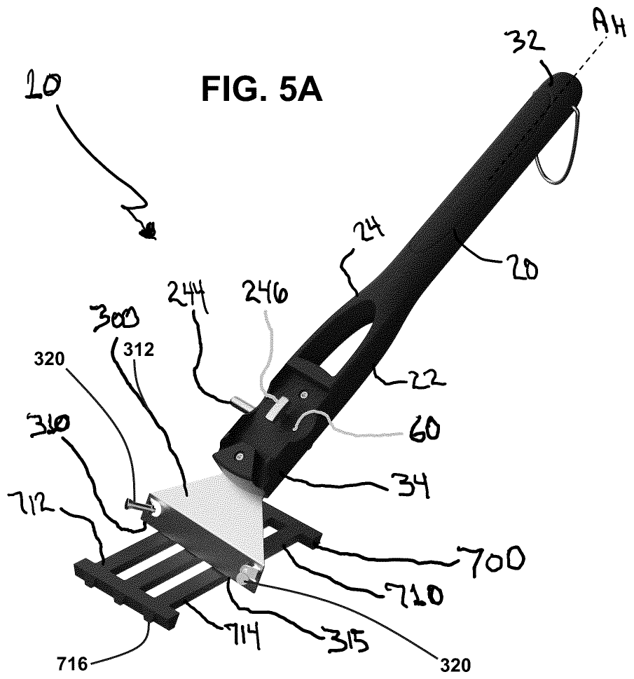

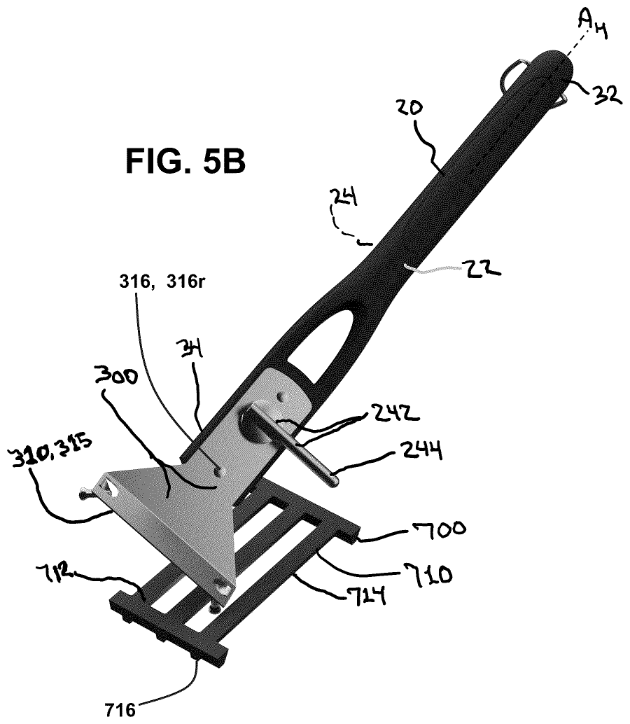

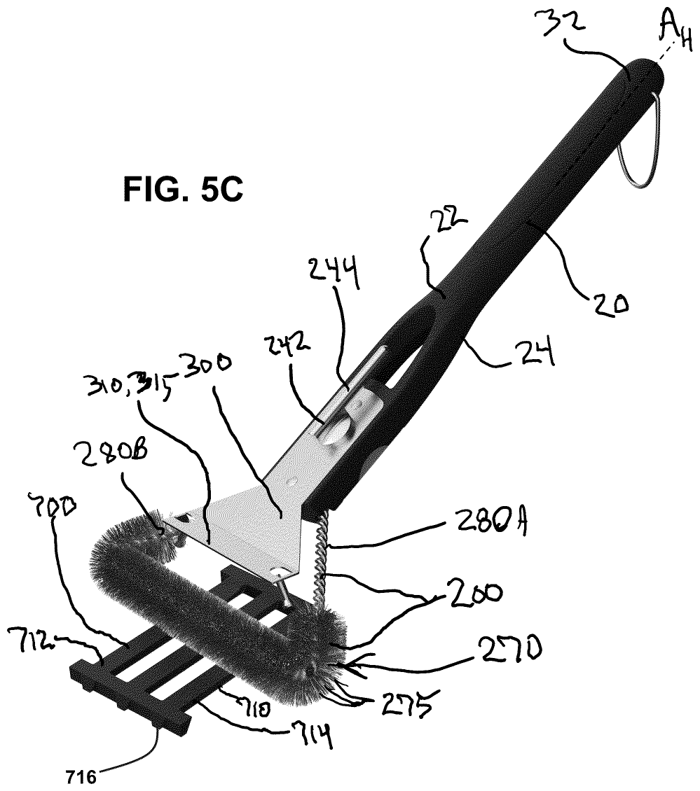

In the version shown exclusively in FIGS. 1 and 4-7, and as the upper of two options in FIG. 3, the distal edge 310 defines a scraping edge 315 configured for engaging and scraping surfaces to be cleaned such as, by way of non-limiting example, the firebox (not shown) and grill-grate bars 710 of a cooking grill grate 700, illustrative sections of which are shown in FIGS. 5A, 5B, and 5C. Moreover, the rigid plate 300 is configured such that the scraping edge 315 extends laterally along an edge axis AE orthogonal to the longitudinal handle axis A_{H}. Although the rigid plate 300 may be configured for direct attachment to or direct dependence from the tool handle 20, as in the embodiments depicted in the drawings, the rigid plate 300 could be attached to the tool handle 20 by an intermediate plate mount, which, while not shown, could essentially be a bracket that retains the rigid plate 300 and, in turn, is secured to the tool handle 20 by fasteners.

In each of the embodiments depicted, the rigid plate 300 is illustratively fastened directly to the tool handle 20 by plate fasteners 316. In various embodiments, it is not envisioned that the rigid plate 300 be removable. Accordingly, relative to such embodiments, the rigid plate 300 may be attached to the tool handle 20 in a manner or by fasteners that are permanent, or “more permanent,” than the manner or fastener(s) by which the brush element 200 is attached to the tool handle 20. Throughout the drawings, the rigid plate 300 is illustratively depicted as secured to the tool handle 20 by rivets 316r.

The brush element 200 and rigid plate 300 are dimensioned and configured in accordance with parameters important to the unique functionality of the grill cleaning tool 10 when the brush element 200 is alternatively attached to and detached from the tool handle 20. Most specifically, in order to facilitate a key objective of various alternative embodiments, the brush element 200 and rigid plate 300 are dimensioned such that, when the brush element 200 is attached to the tool handle 20, at least some of the bristles 275 of the brush head 270 extend longitudinally forward of the distal edge 310 of the rigid plate 300. Among the various drawings, this condition is best depicted in the fully assembled views of FIGS. 1, 1A, and 5C.

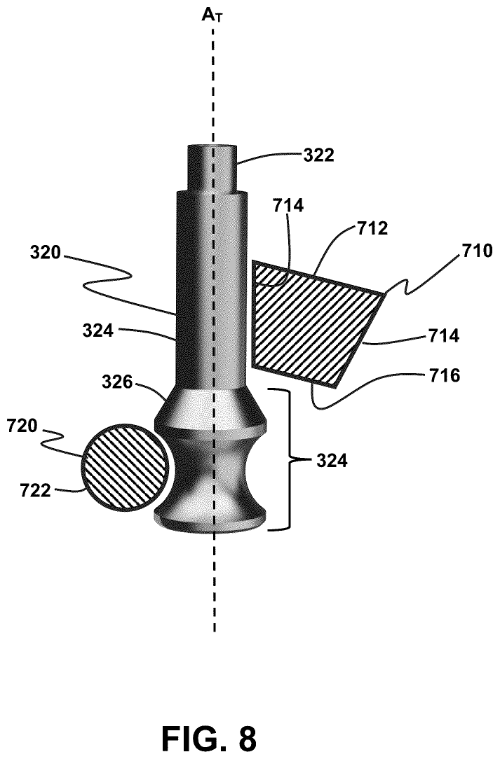

In addition, or alternatively, to defining a scraper blade 312 with a scraping edge 315, the rigid plate 300 in each of various embodiments serves as a bracket to support at least one grill-grate cleaning implement for removing debris from the side and bottom surfaces of grill-grate bars. In each of the embodiments depicted in various drawings, the rigid plate 300 illustratively carries at least one grill-grate-abrading tine 320, hereinafter alternatively referred to as tine(s) 320. Referring primarily to FIGS. 3 and 8 in which two alternatively configured tines 320 are shown with their sub-portions labeled with reference numbers, each tine 320 extends lengthwise along a tine axis A_{T} and includes a tine base 322 by which it is retained by the rigid plate 300, and from which extends a tine shank 324 terminating in a tine tip 325 opposite the tine base 322. For functional reasons explained later in the present description, the tine shank 324 of each tine 320 depicted is substantially cylindrical and at least a portion of each tine tip 325 increases in diameter, relative to the tine shank 324, as a function of increased distance from the tine base 322.

Each rigid plate 300 of the embodiment(s) of FIGS. 1 and 4-7 defines or otherwise has depending therefrom two laterally spaced-apart ears 340 to each of which ears 340 there is attached a tine 320. The ears 340 are angled relative to the overall major lengthwise extent of the rigid plate 300. Stated alternatively, the tines 320 diverge with respect to one another as they extend away from the rigid plate 300. Additionally, in each example depicted, including that of FIG. 1A in which the narrow rigid plate 300 has depending therefrom only a single tine 320, each tine 320 is pitched (i.e., angled) forwardly such that, as a function of increased distance from the rigid plate 300, the tine 320 extends farther forwardly of the handle forward end 34. Stated alternatively, each tine 320 pitched as described is oriented relative to the tool handle 20 such that its tine tip 325 is farther forward of the handle forward end 34 than is the tine base 322 of that same tine 320. As shown in the examples depicted, the forward pitch of each tine 322 is the result of that tine 320 being attached to a portion of the rigid plate 300 forward of a laterally-extending plate bend 305, although this need not be the case. In the particular versions depicted, the laterally-extending plate bend 305 extends perpendicularly to the handle axis A_{H}.

FIGS. 5A, 5B and 5C depict illustrative sections of grill grates 700 including grill-grate bars 710 having top surfaces 712, side surfaces 714, and bottom surfaces 716. FIGS. 5A-C further indicate relative orientations for use of the grill cleaning tool 10 for different purposes. More specifically, FIGS. 5A and 5B depict two alternative orientations in which the grill cleaning tool 10 is used with the brush element detached from the tool handle 20, while FIG. 5C shows an orientation in which the grill cleaning tool 10 is used with the brush element 200 attached to the tool handle 20. With reference to FIG. 5A, in order to use the scraping edge 315 to engage the top surfaces 712 of grill-grate bars 710, the brush element 200 is removed from the handle 20 and the grill cleaning tool 10 is oriented in a generally inverted orientation in which the tool handle bottom surface 24 is above the tool handle top surface 22. The fact the brush element 200 is not attached allows the scraping edge 315 full access to the top surfaces 712 of the grill-grate bars 710. To use the tines 320 to engage and remove debris from side surfaces 714 of grill-grate bars 710, as shown in FIG. 5B, the brush element 200 is removed from the handle 20 and the grill cleaning tool 10 is oriented in a generally upright (non-inverted), but tilted (about the handle axis A_{H}) orientation in which the tool handle bottom surface 24 is below the tool handle top surface 22. The fact that the brush element 200 is not attached allows a tine 320 to access the side surfaces 714 of the grill-grate bars 710. As shown in FIG. 5C, in order to use the brush element 200 to engage the top surfaces 712 of grill-grate bars 710—and other grill surfaces such at the firebox—with the bristles 275 of the brush head 270, the brush element 200 is removed from the handle 20 and the grill cleaning tool 10 is oriented in a generally upright (non-inverted) orientation in which the tool handle bottom surface 24 is below the tool handle top surface 22. The fact that bristles 275 of the brush element 200 are disposed forwardly of the distal edge 310/scraping edge 315 and the tines 320 allows the brush head 270 to access surfaces to be engaged and cleaned thereby without interference from the distal edge 310 of the rigid plate 300 or from the tine(s) 320 depending from the rigid plate 300.

The illustrative tines 320 shown in association with all depicted embodiments do not include bristles; they are rigid structures fabricated from a durable material such as high-temperature polymeric material or metal. In one version, the tines 320 are stainless steel. In addition to the outward mutual divergence of the tines 320 previously discussed, each tine 320 includes a rigid tine shank 324 that, in the versions depicted, is substantially cylindrical. Each tine tip 325 increases in diameter relative to the tine shank 324 as a function of increased distance from the tine base 322. Accordingly, as depicted, at least a portion 326 of each tine tip 325 is substantially conical. As indicated in FIG. 5B, whereas a tine shank 224 may be used to run along and clean the sides 714 of grill-grate bars 710, the grill cleaning tool 10 may be tilted and lifted while inverted to cause an enlarged—in this case, conical—tine tip 225 to run along and remove debris from the bottom surfaces 716 (undersides) of the grill-grate bars 710. It will be appreciated that the mutual divergence of the tines 320—in embodiments including at least two tines 320—facilitates the insertion between grill-grate bars 710 of a single tine 320 at time, rendering the spacing between tines 320 and grill-grate bars 710 irrelevant. The inclusion of a tine 320 laterally disposed on each side of the rigid plate 300 facilitates versatility, particularly relative to grill-grate bars 710 situated at the extreme right and left sides of a grill firebox, for which oppositely-directed brush tilting and opposite tines 320 would be used.

FIG. 8 is a detailed side view of a specially configured tine 320 suitable for effective cleaning of two types of grill-grate bars prevalent in the market. A cross section of each type of bars is shown. The first is shown to the right side of the tine 320 and is a cross-section of the type of grill-grate bar 710 shown in FIGS. 5A-5C. These types of grill-grate bars 710 are substantially trapezoidal as viewed into a cross-sectional plane taken perpendicularly to their lengthwise extent. The cross-sectional plane is not expressly shown or labeled, but can instead be taken to be the plane defined by the drawing sheet on which the cross-sectional image is depicted. An analogous cross-sectional view of a second type of grill-grate bar 720 is shown to the left side of the tine 320. This second type is essentially a cylindrical rod commonly fabricated from steel having a cylindrical surface 722.

The tine 320 of FIG. 8 is uniquely configured to effectively clean either type of grill-grate bar 710 or 720. For much of its length from the tine base 322 to the conical portion 326 of the tine tip 325, the tine 320 of FIG. 8 has substantially the same configuration as the tines 320 shown in previous drawings. It is this portion that is best suited for cleaning the first type of grill-grate bar 710 by using the cylindrical tine shank 324 to engage the side surfaces 714, and the conical portion 326 to engage the bottom surface 716, of each grill-grate bar 710. In addition to increasing in diameter as a function of increased distance from the tine base 322, the tine tip 325 of FIG. 8 then decreases in diameter before again increasing in diameter, as a function of increased distance from the tine base 322 such that, as viewed into a cross-sectional tine plane (i.e., the drawing sheet) that includes the tine axis A_{T}, the tine tip 325 defines a pair of mutually opposed concave arcuate surfaces 328. These concave arcuate surfaces 328 preferably define circular arcs that dimensionally complement the configuration of the cylindrical surface 722 of the grill-grate bar 720, thereby maximizing surface access for scraping away debris.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A grill cleaning tool comprising:
an elongated tool handle extending lengthwise along a longitudinal handle axis between handle rear and forward ends and including a grip portion that extends from the handle rear end toward the handle forward end;
a rigid plate depending from the tool handle and extending forwardly of the handle forward end to a distal edge disposed forwardly of the handle forward end;
a brush element including a brush-element base from which depends a brush head defined by a plurality of bristles, wherein
(i) there is defined on the tool handle a brush-element mount situated more proximate to the handle forward end than to the handle rear end;
(ii) the brush element is selectively attachabale to the tool hand by securing the brush element base to the brush element mount; and
(iii) the brush element and rigid plate are dimensioned and configured such that, when the brush element is attached to the tool handle, at least some of the bristles of the brush head extend longitudinally forward of the distal edge of the rigid plate.

2. The grill cleaning tool of claim 1 wherein the rigid plate is configured as a scraping blade the distal edge of which is a scraping edge configured for engaging and scraping surfaces to be cleaned.

3. The grill cleaning tool of claim 2 wherein the scraping edge extends laterally along an edge axis orthogonal to the handle axis.

4. The grill cleaning tool of claim 3 further comprising at least one grill-grate-abrading tine carried by the rigid plate, and wherein each tine includes a tine base by which that tine is retained by the rigid plate in a location forward of the handle forward end, and from which extends a rigid tine shank terminating in a tine tip opposite the tine base.

5. The grill cleaning tool of claim 4 wherein (a) the tine shank of each tine is substantially cylindrical and (b) at least a portion of each tine tip increases in diameter, relative to the tine shank, as a function of increased distance from the tine base.

6. The grill cleaning tool of claim 5 wherein, in addition to increasing in diameter as a function of increased distance from the tine base, each tine tip then decreases in diameter before again increasing in diameter, as a function of increased distance from the tine base such that, as viewed into a cross-sectional tine plane that includes the tine axis, the tine tip defines a pair of mutually opposed concave surfaces.

7. The grill cleaning tool of claim 4 wherein the rigid plate carries two laterally spaced-apart tines that mutually diverge with respect to one another as they extend away from the rigid plate.

8. The grill cleaning tool of claim 7 wherein, in addition to the diverging with respect to the other tine, each tine is pitched forwardly such that, (i) as a function of increased distance from the rigid plate, the tine extends farther forwardly of the handle forward end and (ii) tine tip is farther forward of the handle forward end than is the tine base.

9. The grill cleaning tool of claim 8 wherein (a) the tine shank of each tine is substantially cylindrical and (b) at least a portion of each tine tip increases in diameter, relative to the tine shank, as a function of increased distance from the tine base.

10. The grill cleaning tool of claim 9 wherein, in addition to increasing in diameter as a function of increased distance from the tine base, each tine tip then decreases in diameter before again increasing in diameter, as a function of increased distance from the tine base such that, as viewed into a cross-sectional tine plane that includes the tine axis, the tine tip defines a pair of mutually opposed concave surfaces.

11. A grill cleaning tool comprising:
a tool handle extending between handle rear and forward ends;
a forwardly-extending rigid plate configured as a scraping blade and depending from the tool handle to a distal scraping edge disposed forwardly of the handle forward end and configured for scraping surfaces to be cleaned; and
a brush element having a brush head defined by a plurality of bristles and being selectively removable from and attachable to the tool handle, the brush element and rigid plate being dimensioned and configured relative to one another such that, when the brush element is attached to the tool handle with the rigid plate, at least some of the bristles extend forwardly of the distal scraping edge.

12. The grill cleaning tool of claim 11 further comprising at least one grill-grate-abrading tine carried by the rigid plate, and wherein each tine includes a tine base by which that tine is retained by the rigid plate in a location forward of the handle forward end, and from which extends a rigid tine shank terminating in a tine tip opposite the tine base.

13. The grill cleaning tool of claim 12 wherein each tine is pitched forwardly such that, (i) as a function of increased distance from the rigid plate, the tine extends farther forwardly of the handle forward end and (ii) tine tip is farther forward of the handle forward end than is the tine base.

14. The grill cleaning tool of claim 13 wherein the rigid plate carries two laterally spaced-apart tines that mutually diverge with respect to one another as they extend away from the rigid plate.

15. The grill cleaning tool of claim 14 wherein (a) the tine shank of each tine is substantially cylindrical and (b) at least a portion of each tine tip increases in diameter, relative to the tine shank, as a function of increased distance from the tine base.

16. A grill-grate-abrading tine extending lengthwise along a tine axis, being configured for attachment to a grill cleaning tool, and comprising a tine base by which that tine is attached to the tool, and from which extends a rigid tine shank terminating in a tine tip opposite the tine base, wherein (a) the tine shank is substantially cylindrical and (b) at least a portion of the tine tip increases in diameter, relative to the tine shank, as a function of increased distance from the tine base.

17. The tine of claim 16 wherein, in addition to increasing in diameter as a function of increased distance from the tine base, each tine tip then decreases in diameter before again increasing in diameter, as a function of increased distance from the tine base such that, as viewed into a cross-sectional tine plane that includes the tine axis, the tine tip defines a pair of mutually opposed concave surfaces.
